(19) United States
(12) Patent Application Publication
(10) Pub. No.: US 2016/0207435 A1
(43) Pub. Date: Jul. 21, 2016

(54) SEAT STRUCTURE, VEHICLE SEAT AND METHOD FOR PRODUCING A VEHICLE SEAT

(71) Applicant: JOHNSON CONTROLS GMBH, Burscheid (DE)

(72) Inventors: Juraj BAGIN, Dubnica nad Vahom (SK); Igor GABOR, Trencin (SK); Pinto Thomas CHIRAYATH, Leichlingen (DE); Holger RÖBKES, Solingen (DE)

(21) Appl. No.: 14/914,964

(22) PCT Filed: Aug. 26, 2014
(86) PCT No.: PCT/EP2014/068070

§ 371 Date: Feb. 26, 2016

(30) Foreign Application Priority Data
Aug. 27, 2013 (DE) 10 2013 014 087.0

(51) Int. Cl. B60N 2/72; B60N 2/68

(52) U.S. Cl. CPC B60N 2/72; B60N 2/68

(57) ABSTRACT

A seat structure, for a vehicle seat (5), has at least one first frame element (2). The seat structure is modular and includes the at least one first frame element. The modular seat structure can be connected to a modular seat cover and is designed as one piece on the frame element, including being designed at least as a hook-shaped receiving element (8) for securing the seat covering.

### CROSS REFERENCE TO RELATED APPLICATIONS

This application is a United States National Phase Application of International Application PCT/EP2014/068070 filed Aug. 26, 2014 and claims the benefit of priority under 35 U.S.C. §119 of German Patent Application DE 10 2013 014 087.0 filed Aug. 27, 2013 the entire contents of which are incorporated herein by reference.

### FIELD OF THE INVENTION

The present invention starts from a seat structure for a vehicle seat having at least one first frame element, wherein the seat structure is constructed in modular fashion from the at least one first frame element and wherein the seat structure can be connected to a modular seat covering.

### BACKGROUND OF THE INVENTION

Such seat structures are widely known and serve to accept the body weight of a vehicle occupant and to hold and protect the vehicle occupant, e.g. in the event of an accident. Such seat structures are generally provided with seat covers. On the one hand, the vehicle seat is of great importance both for ride comfort and for the safety of the vehicle occupant, while, on the other hand, there is a constant effort to reduce production costs for vehicle seats. One possibility of reducing costs is to use the same seat structure of the vehicle seat consistently for different vehicle types. However, this approach is usually not possible since the geometry of the seat structure has to match the available space in the respective vehicle type, with the respective installation space available for the seat structure varying greatly from vehicle type to vehicle type. Both the seat structures and the respective coverings or covers of the seat structures must therefore always be matched to different geometries. Such matching is only ever possible with increased effort and additional costs.

### SUMMARY OF THE INVENTION

It is therefore an object of the present invention to make available a seat structure for a vehicle seat which can be used in a plurality of different vehicle types, allows simple covering with a seat covering and thus ensures relatively low-cost production of vehicle seats.

This object is achieved by a seat structure for a vehicle seat, wherein the seat structure has at least one first frame element, wherein the seat structure is constructed in modular fashion from the at least one first frame element and wherein the seat structure can be connected to a modular seat covering, and wherein furthermore at least one hook-shaped receiving element for securing the seat covering is formed integrally on the first frame element.

As compared with the prior art, the seat structure according to the invention has the advantage both that the seat structure is constructed in modular fashion from the first frame element and that the seat covering to be connected to the seat structure can be of modular design, thus allowing the resulting vehicle seat to be produced at low cost and, in particular, to be matched flexibly to different vehicle types. This is achieved by virtue of the fact that receiving elements, to which the seat covering can be fastened in a simple and flexible manner, are provided on the first frame element. The seat structure preferably comprises the seating surface and/or a backrest of the vehicle seat.

The abovementioned object is furthermore achieved by a seat structure for a vehicle seat which has at least one first frame element and at least one second frame element, wherein the first frame element and the second frame element are arranged at an angle to one another, wherein the seat structure furthermore has a bridge part, by means of which the first frame element and the second frame element are connected to one another, wherein furthermore at least one hook-shaped receiving element for securing a seat covering is formed integrally on the bridge part, integrally on the first frame element, and/or integrally on the second frame element.

As compared with the prior art, the seat structure according to the invention has the advantage that, on the one hand, the first and the second frame element are connected to one another by means of the bridge part, thus enabling the size of the seat part structure to be adjusted in modular fashion simply by cutting the first and the second frame element to an appropriate length and thus enabling it to be matched to any vehicle type, and, on the other hand, that the receiving element makes the seat covering easy to attach in the case of any geometry of the seat part. This gives a seat structure of modular construction which can be used in a very wide variety of vehicle types and therefore ensures low production costs. In particular, the first and the second frame element are aligned substantially at right angles to one another and thus define a plane of the structure which preferably includes the seating plane or a backrest plane. The seat structure preferably comprises the seating surface and/or a backrest of the vehicle seat.

Advantageous embodiments and developments of the invention can be found in the dependent claims and in the description with reference to the drawings.

According to a preferred embodiment of the present invention, it is envisaged that the bridge part comprises a corner connector for connecting the first and the second frame element to one another. It is conceivable for the first and the second frame element each to be capable of being assembled with the corner connector, thus allowing a modular construction of the seat structure in a particularly simple manner. The assembled parts are preferably welded together in addition, preferably by means of laser welding or shielded arc welding. Alternatively, adhesive bonding would also be conceivable.

According to a preferred embodiment of the present invention, it is envisaged that the first frame element and/or the second frame element is/are designed as a hollow profile. The bridge part can then in each case advantageously be inserted partially into the hollow profiles, thereby giving rise to a relatively strong connection by means of positive and/or nonpositive engagement. The hollow profile is preferably manufactured from a bent sheet-like material, in particular from a metal sheet, wherein, in particular, the hollow profile is produced by roll forming and/or stamping of the sheet-like material. In this way, low-cost production of relatively robust frame elements is made possible.

According to a preferred embodiment of the present invention, it is envisaged that a flange of the sheet-like material is angled and wherein the angled flange encloses the receiving element. In particular, only a single flange of the sheet-like material is angled in each case, thus allowing a fastening hook connected to the seat covering to be hooked into the angled flange piece in order to secure and stretch the seat covering on the seat structure in a simple manner. A foam material as cushioning is furthermore preferably inserted between the seat covering, in particular a flexible, large-area seat cover, and the seat structure.

According to a preferred embodiment of the present invention, it is envisaged that the seat structure has further first frame elements, further second frame elements and further bridge parts. In this way, it is possible to form a frame, in particular a closed frame, as the seat structure, the geometry and shape of which can be matched in modular fashion to the individual circumstances of the respective vehicle type. In this case, the frame elements, in particular, are connected to one another by means of the bridge parts, at least in corner regions of the seat structure. The seat structure is thus constructed, in particular in modular fashion, from the first frame element, the second frame element, the bridge part, further first frame elements, further second frame elements and/or further bridge parts.

The seat covering is likewise of modular design or replaceable and connected to the seat structure.

The present invention furthermore relates to a vehicle seat having the seat structure according to the invention, wherein the vehicle seat has a seat covering, which is secured on the at least one receiving element by means of fastening hooks. The vehicle seat can advantageously be produced at relatively low cost and, by virtue of its modular construction, can be matched flexibly to any installation space configuration. A foam cushion is preferably arranged at least partially between the seat covering and the seat structure in order to pad the vehicle seat. By virtue of the abovementioned modularity of the seat structure and the modularity of the seat covering, the vehicle seat according to the invention can advantageously be produced at low cost and matched to any desired installation space configuration of a particular vehicle type.

The present invention furthermore relates to a method for producing the vehicle seat, in particular the vehicle seat according to the invention, wherein a first frame element and a second frame element are made available in a first method step and wherein the first frame element and/or the second frame element are cut to length in a second method step, wherein the first frame element and the second frame element are connected to one another at an angle by means of a bridge part in a third method step, wherein a seat covering is fitted in a fourth method step by hooking fastening hooks connected to the seat covering into receiving elements formed integrally on the first frame element, integrally on the second frame element and/or integrally on the bridge part. To match the seat structure to a desired installation space configuration in a vehicle, appropriate cutting to length of the frame elements is advantageously all that is required, while simple, quick and low-cost fastening of the seat covering by means of the fastening hooks is always made possible by means of the integrally formed or shaped receiving elements. In comparison with the prior art, a more flexible and less expensive construction of the vehicle seat is thus made possible. In comparison with the prior art, a more flexible and less expensive construction of the vehicle seat is thus made possible.

The present invention furthermore relates to a method for producing the vehicle seat according to the invention, wherein a first frame element is made available in a first method step and wherein the first frame element is cut to length and/or bent in a second method step, wherein a seat covering is fitted in a fourth method step by hooking fastening hooks connected to the seat covering into receiving elements formed integrally on the first frame element.

According to a preferred embodiment of the present invention, it is envisaged that the first and/or second frame element is/are produced in the form of a hollow profile by roll forming and/or stamping a sheet-like material, in particular a metal sheet, in the first method step. It is conceivable for the first frame element and the second frame element to be connected to the bridge element by means of a welding method, preferably by means of laser welding or shielded arc welding. As an alternative, adhesive bonding would also be conceivable.

Further details, features and advantages of the invention can be found in the drawings and in the following description of preferred embodiments with reference to the drawings. At the same time, the drawings illustrate merely illustrative embodiments of the invention, which do not restrict the essential inventive concept.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is schematic views of a seat structure according to an illustrative embodiment of the present invention;

FIG. 2 is a schematic detail view of a vehicle seat having a seat structure according to the illustrative embodiment of the present invention;

FIG. 3 is a schematic perspective view of a seat structure according to a further illustrative embodiment of the present invention;

FIG. 4 is a schematic detail view of the seat structure according to the further illustrative embodiment of the present invention; and

FIG. 5 is a schematic view of a vehicle seat according to a further illustrative embodiment of the present invention.

### DESCRIPTION OF THE PREFERRED EMBODIMENTS

In the various figures, identical parts are in all cases provided with the same reference signs and are therefore generally also named and mentioned only once in each case.

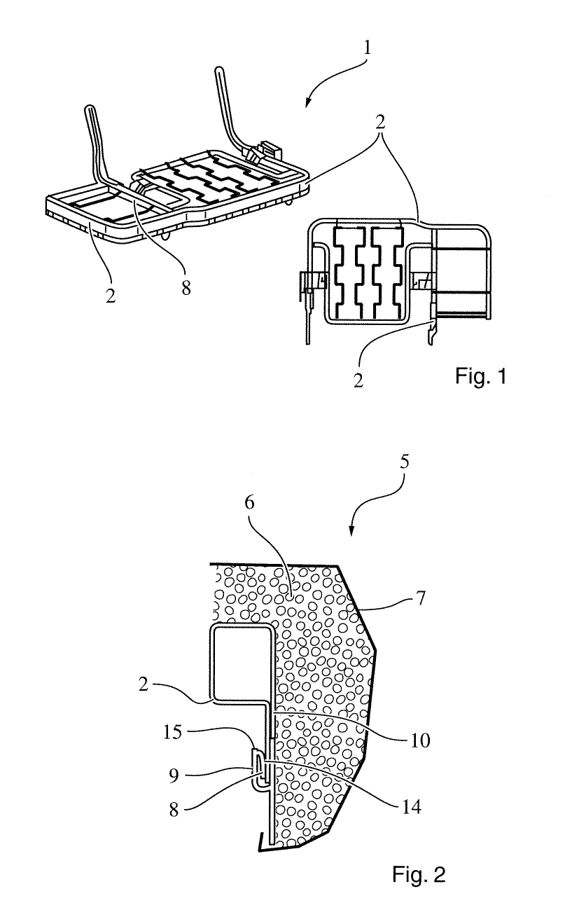

FIG. 1 illustrates a schematic perspective view and a schematic plan view of a seat structure 1 according to an illustrative embodiment of the present invention. In the example under consideration, the seat structure 1 serves as a load-bearing base structure for the horizontal seating surface of a folding rear seat bench, which needs only to be provided with a cushion 6 and a seat covering 7 to produce a vehicle seat 5.

The seat structure 1 comprises a first frame element 2, which acts as a basic support for the vehicle seat 5. For this purpose, the first frame element 2 is formed or bent in accordance with the external geometry of the vehicle seat to be produced. The first frame element can thus be matched to the specific installation space available in a specific vehicle type. It is furthermore conceivable for the first frame element 2 to be expanded in modular fashion by further frame elements in order to obtain a desired support configuration. The first frame element 2 comprises a hollow body, which is produced by roll forming a sheet-like material. It is conceivable for the hollow body to comprise a box section. The first frame element 2 is provided at least in part with a receiving element 8, which is used to secure a seat covering (see FIG. 2). In this arrangement, the receiving element 8 is formed integrally with the first frame element 2, thus advantageously eliminating the need for any additional frame component element to secure the seat covering 7.

FIG. 2 shows a schematic detail view of the seat structure 1 shown in FIG. 1 and of a vehicle seat 5 according to the illustrative embodiment of the present invention. The detail views show sectional illustrations, in which it can be seen that the hollow profile is constructed by rolling and joining the flanges of the sheet-like material together as in a joining seam 10. In this arrangement, the receiving element 8 is formed by an extension of a flange of the sheet-like material in the region of the joining seam 10, wherein the extension is angled, thus giving rise to a hook-shaped receiving element 8. A fastening hook 9 firmly connected to the seat covering 7 is then snapped releasably into the receiving element 8 in order to stretch the seat covering 7 and secure it on the first frame element 2. A cushion 6 is furthermore arranged between the seat structure 1 and the seat covering 7. The fastening hook 9 comprises a base plate 14, from which a hook latching element 15 projects, this being curved in such a way that a free end of the hook latching element 15 extends parallel to the base plate 14. The base plate 14 is inserted partially behind the flange of the sheet-like material, while the hook latching element 16 engages behind the hook-shaped receiving element 8. For this purpose, the hook latching element 16 and the receiving element 8 each have an undercut. The seat covering 7 can be hooked into the first frame element 2 at any desired location by means of the fastening hook 9, thereby allowing a modular construction not only of the seat structure 1 but also of the seat covering 7.

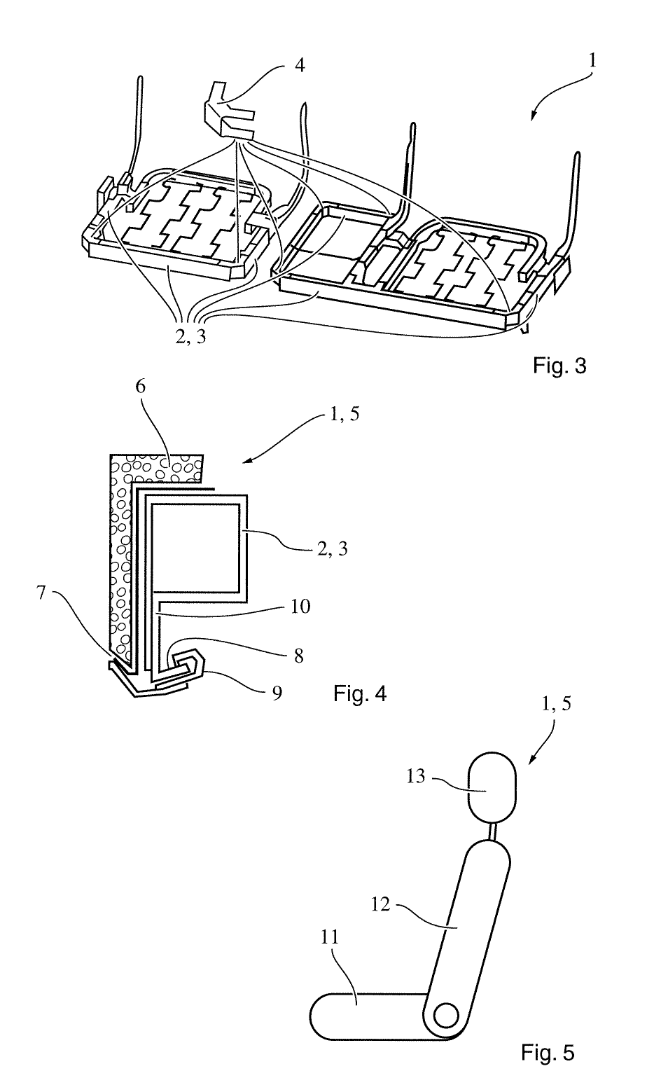

FIG. 3 shows a schematic perspective view of a seat structure 1 for a vehicle seat 5 according to a further illustrative embodiment of the present invention. Here too, as in the case of the seat structure 1 shown by means of FIG. 1, the seat structure 1 serves as a load-bearing base structure for the horizontal seating surface of a folding rear seat bench, which has only to be provided with a cushion 6 and a seat covering 7 to produce a vehicle seat 5.

The seat structure 1 comprises a plurality of first frame elements 2 and a plurality of second frame elements 3. The first and second frame elements 2, 3 are connected to one another in corner regions of the seat structure 1 by means of bridge parts 4. The bridge parts 4 each comprise clips open on one side, in which the first and second frame elements 2, 3, which are designed as hollow profiles, are arranged with positive engagement and are welded to the respective bridge part 4. The first and second frame elements 2, 3 are each aligned substantially at right angles to one another. It is conceivable for the first frame elements 2 to consist entirely of cross members, while the second frame elements 3 consist entirely of longitudinal members. A bridge part 4 is then arranged in each of the corners of the seat structure 1, in which a first and a second frame element 2, 3 have to be connected to one another, in order to connect the corresponding first and second frame element 2, 3.

The first and second frame elements 2, 3 are each provided with a hook-shaped receiving element 8, into which a fastening hook 9 of a seat covering 7 can be hooked. The hook-shaped receiving element 8 is in each case formed integrally on the first and second frame element 2, 3.

To construct the seat structure 1, the first and second frame elements 2, 3 need only be cut to the correct length and then assembled and joined to the bridge parts 4 to give a desired shape and geometry. In this way, a modular construction of a seat structure 1 is possible, which can be matched to any desired installation space configuration of a particular vehicle type in a simple manner. At the same time, the designs of the individual frame elements 2, 3 and of the bridge parts 4 remain identical and can thus be used for a large number of differently designed seat structures 1. In this way, the production costs for the respective seat structures 1 and the vehicle seats 5 based thereon can be reduced in comparison with the prior art.

FIG. 4 shows a schematic detail view of the seat structure 1 according to the further illustrative embodiment of the present invention illustrated in FIG. 3. The detail view shows a section through a first or second frame element 2, 3 illustrated in FIG. 1, which is furthermore already provided with a cushion 6 and a seat covering 7. It can be seen that the first or second frame element 2, 3 is a hollow profile, which has been produced by roll forming a sheet-like material. In this arrangement, the hollow profile has a joining seam 10, in which the rolled sheet-like material is joined together. According to the invention, the hollow profile is designed in such a way that a flange of the sheet-like material projects beyond the joining seam 10 and is angled. This projecting and angled flange forms the receiving element 8.

To produce the vehicle seat 5, the seat structure 1 is provided with a cushion 6, in particular one composed of a foam material. A seat covering 7 (also designated as a seat cover) is then stretched over the cushion 6. The seat covering 7 is connected to fastening hooks 9, which are simply hooked into the receiving elements 8 on the underside of the vehicle seat 5. This means that the seat covering 7 can also be of modular design and can be secured in a simple manner on a seat structure 1 of any design.

FIG. 5 shows a schematic view of a vehicle seat 5 according to the further illustrative embodiment of the present invention. The vehicle seat 5 has the above-described seat structure 1, which is covered by the cushion 6 and the seat covering 7. In addition to the seating surface part 11 constructed in this way, the vehicle seat 5 comprises a backrest 12 and a head restraint 13. It is conceivable for the backrest 12 likewise to be constructed from the modular seat structure 1 in the manner described above. As an alternative, the vehicle seat 5 shown in FIG. 5 could also be provided with the seat structure 1 shown in FIG. 1.

While specific embodiments of the invention have been shown and described in detail to illustrate the application of the principles of the invention, it will be understood that the invention may be embodied otherwise without departing from such principles.

1. A seat structure for a vehicle seat, the seat structure comprising at least one first frame element, wherein
the seat structure is constructed modularly from the at least one first frame element;
the seat structure can be connected to a modular seat covering
at least one hook-shaped receiving element for securing the seat covering is formed integrally on the first frame element.

2. A seat structure for a vehicle seat, the seat structure comprising:
a bridge part;
at least one first frame element; and
at least one second frame element, wherein:
the first frame element and the second frame element are arranged at an angle to one another;
the bridge part connects the first frame element and the second frame element to one another;
at least one hook-shaped receiving element for securing a seat covering is formed integrally on the bridge part, integrally on the first frame element integrally on the second frame element or formed integrally on any combination of the bridge part, the first frame element, and the second frame element.

3. The seat structure as claimed in claim 2, wherein the bridge part comprises a corner connector connecting the first and the second frame element to one another.

4. The seat structure as claimed in claim 3, wherein the first and the second frame element are aligned substantially at right angles to one another and wherein the bridge part comprises a clip open on one side for receiving end regions of the first and of the second frame element.

5. The seat structure as claimed in claim 2, wherein the first frame element or the second frame element is configured as a hollow profile or both the first frame element and the second frame element are configured as a hollow profile.

6. The seat structure as claimed in claim 5, wherein the hollow profile is manufactured from a bent sheet material comprised of a metal sheet, and the hollow profile is produced by roll forming or stamping of the sheet material or produced by both roll forming and stamping of the sheet material.

7. The seat structure as claimed in claim 6, wherein a flange of the sheet material is angled and wherein the angled flange encloses the receiving element.

8. The seat structure as claimed in claim 2, further comprising a further first frame element, a further second frame element or a further bridge part or any combination of a further bridge part, a further first frame element, and a further second frame element.

9. The seat structure as claimed in claim 8, wherein the seat structure is constructed modularly from the first frame element, the second frame element, the bridge part, a further first frame element, a further second frame element or a further bridge part or any combination of a further bridge part, a further first frame element, and a further second frame element.

10. The seat structure as claimed in claim 2 in combination with a seat covering comprising at least one fastening hook, the seat covering being secured on the at least one receiving element by means of the at least one fastening hook (9).

11. The seat structure as claimed in claim 10, in combination with a foam cushion arranged at least partially between the seat covering and the seat structure.

12. A method for producing a vehicle seat, the method comprising the steps of:
providing a first frame element that is cut to length or bent or cut to length and bent;
fitting a seat covering by hooking fastening hooks connected to the seat covering into receiving elements formed integrally on the first frame element.

13. A method for producing a vehicle seat, the method comprising the steps of:
providing a first frame element and a second frame element wherein the first frame element or the second frame element is cut to length
providing a bridge part;
connecting the first frame element and the second frame element to one another at an angle by means of the bridge part
fitting a seat covering by hooking fastening hooks connected to the seat covering into receiving elements formed integrally on the first frame element, or into receiving elements formed integrally on the second frame element or into receiving elements formed integrally on the bridge part or into receiving elements formed integrally on any combination of the first frame element, the second frame element and the bridge part.

14. The method as claimed in claim 13, wherein the first or second frame element or both the first and the second frame element is produced in the form of a hollow profile by roll forming or stamping a sheet material or by both roll forming and stamping.

15. The method as claimed in claim 12, wherein the first frame element is produced in the form of a hollow profile by roll forming or stamping a sheet material or by both roll forming and stamping.

16. The method as claimed in claim 13, wherein the bridge part comprises a corner connector connecting the first and the second frame element to one another.

17. The method as claimed in claim 16, wherein the first and the second frame element are aligned substantially at right angles to one another and wherein the bridge part comprises a clip open on one side for receiving end regions of the first and of the second frame element.

18. The method as claimed in claim 14, wherein a flange of the sheet material is angled and wherein the angled flange encloses the receiving element.

19. The method as claimed in claim 13, further comprising providing a further first frame elements, a further second frame elements or a further bridge part or providing any combination of a further bridge part, a further first frame element, and a further second frame element.

20. The method as claimed in claim 19, wherein the seat structure is constructed modularly from the first frame element, the second frame element, the bridge part, a further first frame element, a further second frame element or a further bridge part or any combination of a further bridge part, a further first frame element, and a further second frame element.
